(19) United States
(12) Patent Application Publication
(10) Pub. No.: US 2020/0124074 A1
(43) Pub. Date: Apr. 23, 2020

(54) FRAMES FOR GEOMETRIC SOLIDS AND METHODS OF USE THEREOF

(71) Applicant: TORUS TECH, INC., San Clemente, CA (US)

(72) Inventors: Nassim Haramein, Carlsbad, CA (US); Scott Brown, San Clemente, CA (US); William Brown, San Clemente, CA (US)

(21) Appl. No.: 16/657,849

(22) Filed: Oct. 18, 2019

Related U.S. Application Data
(60) Provisional application No. 62/747,586, filed on Oct. 18, 2018.

(51) Int. Cl. F16B 9/02; C02F 1/00

(52) U.S. Cl. CPC F16B 9/02; C02F 1/005

(57) ABSTRACT

Systems and methods that can be used to improve or treat a fluid (e.g., water) that can be subsequently fed to a living system (e.g., plant) to increase its vitality. Contemplated systems comprise a frame that holds crystals. The frame comprises outer arms and inner arms that hold crystals in a specific orientation. For example, the outer arms and the inner arms can form a tetrahelix that thereby hold the crystals in a tetrahelical orientation across the length of the frame. Contemplated systems can be installed in new or existing water systems to thereby improve or treat the water before it is subsequently fed to a living system (e.g., plant).

This application claims priority to U.S. Provisional Application Ser. No. 62/747,586, filed Oct. 18, 2019. All extrinsic materials identified herein are incorporated by reference in their entirety.

### FIELD OF THE INVENTION

The field of the invention is frames, especially frames for geometric solids used to improve a substance (e.g., water) that can be subsequently fed to living systems to improve their vitality.

### BACKGROUND

The background description includes information that may be useful in understanding the present invention. It is not an admission that any of the information provided herein is prior art or relevant to the presently claimed invention, or that any publication specifically or implicitly referenced is prior art.

These and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

Geometric solids (e.g., gems, crystals, etc.) are often mounted on a frame to form an ornamental or wearable item. For example, Fullin (French Patent App. Pub. No. FR 2618311) discloses a modular pendant for earrings having two elements with triangular profiles that couple to one another in a few different configurations via a housing and an apparent snap-fit connection between the housing and the two elements. Others have contemplated frames for geometric solids that can be used for other purposes. For example, Haramein (U.S. Pat. No. 9,466,228) discloses modular frames for geometric solids that can be used as an educational tool to demonstrate or investigate effects of a geometric solid in an environment.

Although frames for geometric solids have been disclosed, there is still a need in the art for improved frames for geometric solids.

### SUMMARY OF THE INVENTION

The inventive subject matter provides apparatus, systems, and methods in which a system can be used to improve a fluid (e.g., water) that can be subsequently be fed to living systems (e.g., plants) to increase their vitality. One contemplated system comprises a frame, a first crystal and a second crystal. The frame comprises outer arms that collectively wind about a major axis of the frame, and inner arms that extend within the outer arms. The first and second crystals each comprise a first face. When placed within the frame, at least one of the outer arms and at least one of the inner arms extend over (i) a portion of the first crystal and (ii) a portion of the second crystal to thereby orient the first crystal with respect to the second crystal such that the first face of the first crystal contacts the first face of the second crystal. It should be appreciated that fluid (e.g., water) that passes through the system is improved for use by living systems (e.g., plants) to increase their vitality.

It is contemplated that the outer arms and the inner arms can collectively form a tetrahelix that retains the crystals in a tetrahelical orientation. One or more of the crystals can be a quartz crystal. Additionally, or alternatively, one or more of the crystals can be a tetrahedral shape. Furthermore, it should be appreciated that the system can be installed in new or existing water systems to thereby modify the water to provide enhanced benefits.

In another aspect, a method of treating water to produce treated water is contemplated. The method comprises feeding the water to a water treatment system having (i) a frame having outer arms that collectively wind about a major axis of the frame, and inner arms that extend within the outer arms and (ii) crystals disposed within the frame in an amount sufficient to cause the water to spin as it flows across the water treatment system thereby producing the treated water.

In yet another aspect, a method of improving a living system with treated water is contemplated. The method comprises feeding water in a water treatment system having (i) a frame comprising outer arms that collectively wind about a major axis of the frame, and inner arms that extend within the outer arms and (ii) crystals disposed within the frame to thereby produce treated water. The method further comprises feeding the treated water to the living system to thereby improve the living system. It is contemplated that the living system is a plant, and one or more of growth density, growth rate, seed viability, pathogen resistance, and phytonutrient concentration of the plant is improved.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

FIG. 1 is a perspective view of an embodiment of a system comprising a frame and crystals.

FIG. 2 is a front view of the system of FIG. 1.

FIG. 3 is a perspective of the frame of the system of FIG. 1.

FIG. 4 is another perspective view of the frame of FIG. 3.

FIG. 5 is a partially exploded view of the frame of FIG. 3.

FIG. 6 is a perspective view of the outer arms of the frame of FIG. 3.

FIG. 7 is a perspective view of the inner arms of the frame of FIG. 3.

FIG. 8 is another perspective view of the system of FIG. 1.

FIG. 9 is a perspective view of the crystal orientation of the system of FIG. 1.

FIG. 10 is another perspective view of the crystal orientation of FIG. 9.

FIG. 11 is a front view of an embodiment of multiple systems of FIG. 1 disposed in a pipe.

FIG. 12 is a partially cutaway view showing the multiple systems of FIG. 1 disposed in the pipe.

FIG. 13 is a front view of another embodiment of multiple systems of FIG. 1 disposed in a pipe.

FIG. 14 is a partially cutaway view showing the multiple systems of FIG. 1 disposed in the pipe.

FIG. 15 is a perspective view of an embodiment of a system comprising a frame and crystals disposed within a housing.

FIG. 16 is an exploded view of the embodiment of FIG. 15.

FIG. 17 is a cross-sectional view of the embodiment of FIG. 15 along the line 17-17 in FIG. 15.

FIG. 18 is a perspective view of the frame of the system of FIG. 15.

FIG. 19 is a bottom perspective view of an end cap of the housing of FIG. 15.

FIGS. 20A and 20B show charts on data measured related to relative stalk length between different test groups and a control group.

FIGS. 21A and 21B show an image of a setup of a spectrophotometric measurement, and a chart of spectrophotometric measurements between a test groups and a control group.

FIGS. 22A and 22B shows an image of a radish of a test group and a control group, and a chart based on weight measurements.

FIGS. 23A and 23B show an image of seed production between a test group and a control group, and a chart based on such production values.

### DETAILED DESCRIPTION

The following discussion provides example embodiments of the inventive subject matter. Although each embodiment represents a single combination of inventive elements, the inventive subject matter is considered to include all possible combinations of the disclosed elements. Thus, if one embodiment comprises elements A, B, and C, and a second embodiment comprises elements B and D, then the inventive subject matter is also considered to include other remaining combinations of A, B, C, or D, even if not explicitly disclosed.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

Also, as used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously. Moreover, and unless the context dictates the contrary, all ranges set forth herein should be interpreted as being inclusive of their endpoints and open-ended ranges should be interpreted to include only commercially practical values. Similarly, all lists of values should be considered as inclusive of intermediate values unless the context indicates the contrary.

The inventors have discovered that the vitality of living systems (e.g., plants) can be improved by feeding a fluid or substance (e.g., water) that has been treated with a system comprising a frame and at least one crystal to the living system. Additionally, or alternatively, the vitality of living systems can be improved by feeding a fluid or substance that is treated by indirect exposure to the system comprising the frame and at least one crystal (i.e., the fluid or substance does not directly contact the system). For example, the system can be located in a position where it does not directly contact the fluid or substance and is within 10 centimeters of (i) the fluid or substance or (ii) a container that contains the fluid or substance (e.g., a water pipe or vessel, or a water tank). In another example, the system can be located in a position where it does not directly contact the fluid or substance and is within 1 centimeter of (i) the fluid or substance or (ii) a container that contains the fluid or substance (e.g., a water pipe or vessel, or a water tank). When the system does not directly contact the fluid or substance, it is contemplated that the distance between substance or fluid and the system can vary depending on the number of crystals used, such that the system can be placed at a further distance if 15-30 crystals are used, but shorter distances if 1-15 crystals are used.

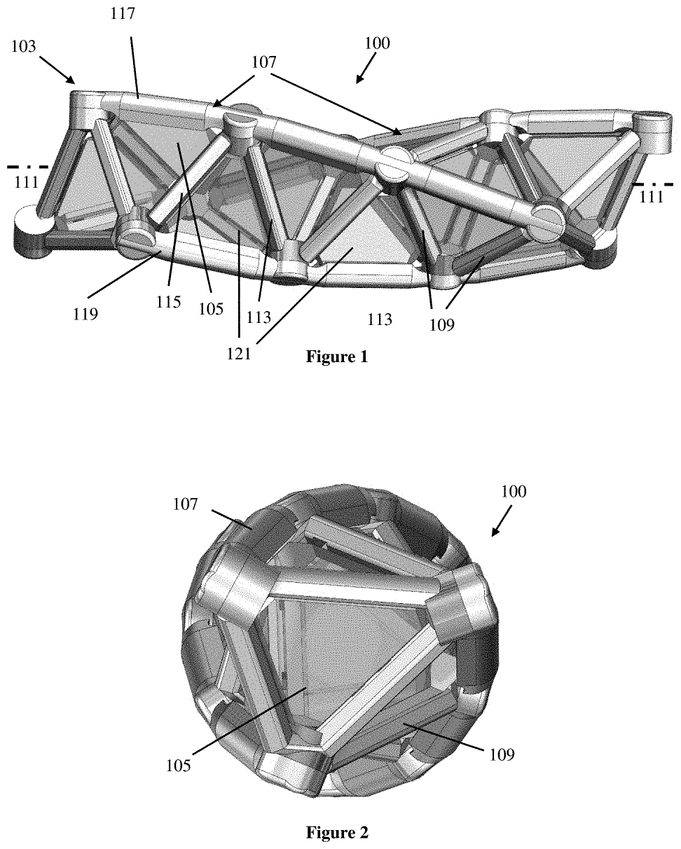

FIG. 1 shows an embodiment of a system 100 comprising a frame 103 and crystals 105. Frame 103 comprises outer arms 107 and inner arms 109 that retain crystals 105. As shown in FIG. 1, outer arms 107 collectively wind about a major axis 111 of frame 103. Inner arms 109 extend within outer arms 107. It is contemplated that outer arms 107 and inner arms 109 collectively form a tetrahelix to thereby hold crystals 105 in a tetrahelical orientation.

System 100 can be installed in new or existing water systems to treat water via contact between the water and system 100. For example, system 100 can be fixed in a pipe and/or tank of a water system, such that water contacts the system before exiting the system or housing containing the system. It is contemplated that system 100 can remain within new or existing water systems, or in other fluid systems, for several years without maintenance. Maintenance of system 100 may be required if crystals 105 are physically damaged, violently shocked, or are overheated. For example, crystals 105 can be damaged if (i) over 10 g of sudden force is applied to a crystal, (ii) very high electromagnetic fields resonate with the crystal for exposure to temperatures above approximately 200° C., or (iii) the crystal is exposed to near or above the α-quartz to β-quartz transformation temperature of 573° C. It is contemplated that system 100 as a whole or a component of system 100 (e.g., frame 103, an outer arm 107, an inner arm 109, and/or a crystal 105) can be removed and replaced as needed.

As shown in FIG. 1, outer arms 107 comprise three outer arms that curve or wind about major axis 111 along the length of frame 103. Outer arms 107 removably couple with inner arms 109 to thereby retain crystals 105. In some embodiments, one or more of inner arms 109 are removably coupled to each other to thereby allow crystals 105 to be installed or removed. Once crystals 105 are installed, inner arms 109 could be coupled, and outer arms 107 could couple with inner arms 109 to thereby retain crystals 105. In other embodiments, crystals 105 can be permanently installed in frame 103, such that crystals 105 are not removable. In such embodiment, outer arms 107 and inner arms 109 could be permanently affixed to each other.

Inner arms 109 typically extend between two of outer arms 107. For example, a first inner arm 113 and a second inner arm 115 can extend between a first outer arm 119 and a second outer arm 117 as shown in FIG. 1. Frame 103 can further comprise openings 121 that allow users to view crystals 105. It is contemplated that openings 121 can each have a boundary defined by at least one of the outer arms 107 and at least one of the inner arms 109. For examples, openings 121 comprises an opening having a triangular-shaped boundary defined by first outer arm 119, first inner arm 113, and second inner arm 115.

Crystals 105 are retained within frame 103 by outer arms 107 and inner arms 109 that extend over portions of each of the crystals. For example, at least one of the outer arms 107 and at least one of the inner arms 109 can extend over a portion of a first crystal and a portion of a second crystal to thereby orient the first crystal with respect to the second crystal in a tetrahelical orientation.

As discussed above, it is contemplated that the outer arms 107 and inner arms 109 form a tetrahelix, which thereby orients crystals 105 in a tetrahelical orientation. Without being bound to any theory, it is theorized that mimicking the spiral vortex of DNA, as frame 103 does, when placed within running water, will have superior exposure of the crystal's field of operation over a linear orientation of the frame. In addition, a spiral vortex flow created by the tetrahelix design of frame 103 further improves the effect on water.

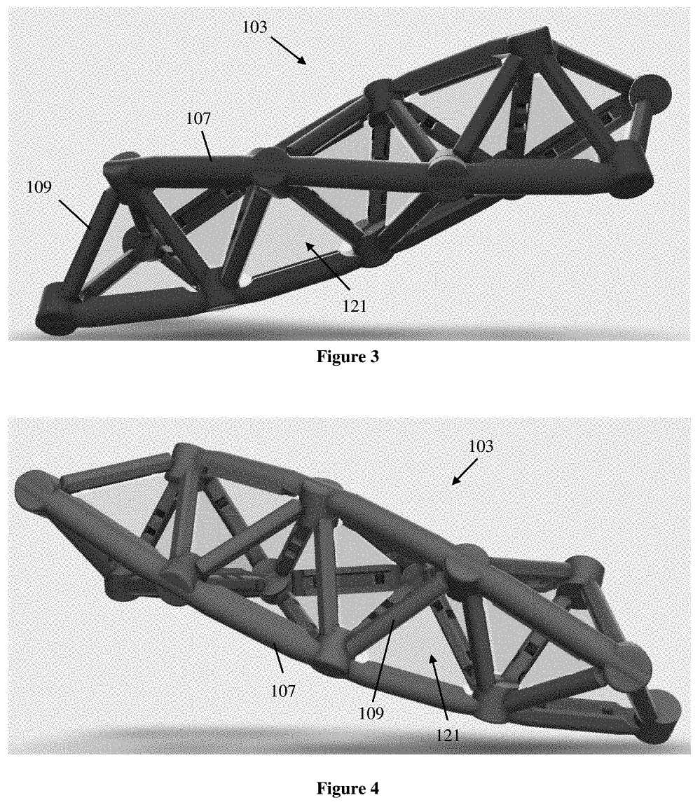

FIG. 2 shows a front view of the tetrahelix shape of frame 103. Alternatively, it is contemplated that frame 103 can be linear, such that outer arms 107 are straight and crystals 105 are retained in a linear orientation. Furthermore, it is contemplated that frame 103 can be circular, such that crystals 105 are retained in a circular orientation. Thus, it is contemplated that frame 103 can be tetrahelical, linear, circular, or any other geometric shape to thereby retain crystals 105 in a geometric form, including a cubeoctahedron, a sphere, a pyramid, an isotropic vector matrix, a spiral, or other forms based on the constants of nature (e.g., phi, Euler, etc.). System 100 having a particular design (e.g., tetrahelical, linear, circular, etc.) for frame 103 can then be disposed around or within a fluid (e.g., water), or a container (e.g., a water tank or pipe) holding the fluid to thereby treat or improve the fluid.

Frame 103 can hold between 1 and 10 crystals. However, it should be appreciated that a higher or lower number of outer arms and/or inner arms can be manufactured to produce a frame that can accommodate a higher or lower number of crystals. For example, in one embodiment, the frame can be approximately 120 mm in length and 28 mm in height to accommodate 10 crystals. It should be appreciated that contemplated frames can hold from 1 to 144 crystals in a specific geometric form (e.g., tetrahelical, linear, circular, etc.). The frame can be a metal, a ceramic, or a rigid or semi-rigid polymer. For example, the frame can be a titanium alloy (e.g., Ti-6A1-4V) or a stainless steel alloy (e.g., stainless steel 316L).

Crystals 105 can be quartz crystals having a tetrahedral shape. For example, crystals 105 can have a modified tetrahedral shape having four triangular faces joined at four truncated vertices and six chamfered edges. Suitable crystals are discussed in U.S. Pat. Nos. 9,745,669, 9,435,054, 9,834,862, and 10,094,046, which are hereby incorporated by reference. It is contemplated that crystals can be a synthetic form of naturally occurring crystal types, such as quartz, ruby, and diamond.

Crystals 105 can be exposed to an electromagnetic field produced by a generator prior to being installed in the frame. Suitable generators are discussed in U.S. Pat. Nos. 8,073,094, 8,130,893, 8,933,595, 9,497,844, and 9,949,355, which are hereby incorporated by reference. It is contemplated that the electromagnetic field is sufficient to thereby cause oscillation of the piezoelectric (electromechanical) axis of crystals 105. For example, crystals 105 can be exposed to a circularly modulated electromagnetic field for a total of two hours.

FIGS. 3-4 show alternative views of frame 103 having inner arms 109 and outer arms 107 forming a tetrahelix shape. As described above, it is contemplated that frame 103 has openings 121 formed throughout outer arms 107 and inner arms 109 that allows faces of crystals 105 to be visible (see FIG. 1 showing faces of crystals exposed through openings 121). Additionally, it is contemplated that (i) outer arms 107 can cover at least a portion of edges and vertices of crystals 105 and/or (ii) inner arms 109 can cover areas where the faces of two adjacent crystals contact.

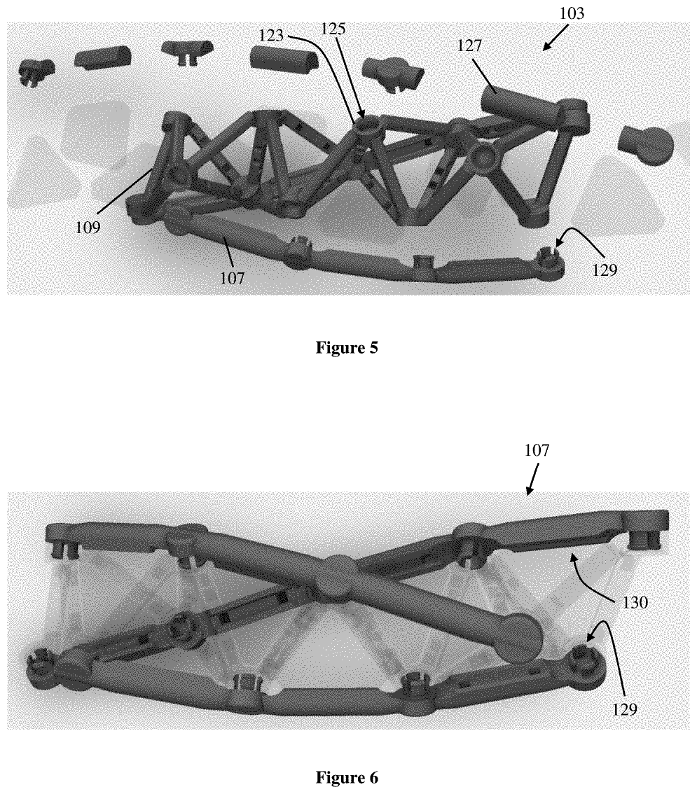

As described above, outer arms 107 could be removably coupled with inner arms 109. FIG. 5 shows a partially exploded view of frame 103 showing outer arms 107 uncoupled from inner arms 109. As shown, outer arms 107 can comprise clips 129 that can be inserted into recesses 125 to thereby couple outer arms 107 with inner arms 109. Additionally, or alternatively, it is contemplated that outer arms 107 and inner arms 109 can be coupled using magnets. Although clips 129 and recesses 125 are shown in FIG. 5, it is contemplated that outer arms 107 and inner arms 109 can have other connectors (e.g., a projection that is received by a recess/aperture).

FIG. 5 shows that at least one of the outer arms 107 can be separated into outer arm subunits 127. It should be appreciated that outer arm subunits 127 allow a user to replace a portion of the outer arm (e.g., a clip) instead of having to replace the entire outer arm. Additionally, or alternatively, inner arms 109 can be separated into subunits (e.g., single inner arms 109 and catch units 123). In other embodiments, outer arms 107 and/or inner arms 109 can be a single, unitary unit (i.e., not separable into subunits).

FIG. 6 shows a perspective view of outer arms 107 in an assembled orientation. As described above, 107 outer arms have a curvature that resembles a tetrahelix. In other words, outer arms 107 can wind about major axis 111 of frame 103 to form a tetrahelix. Each of outer arms 107 has clips 129 along its length. It is contemplated that a higher or lower number of clips can be used if needed. Outer arms 107 can further comprise cover portions 130 that cover and/or conforms to at least a portion of an edge of a crystal. Typically, cover portions 130 are disposed between two adjacent clips 129.

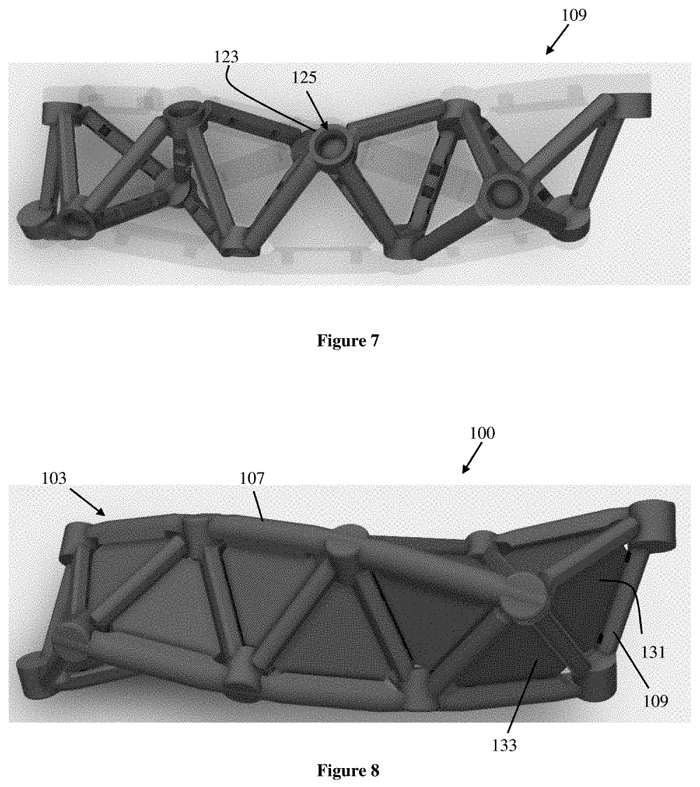

FIG. 7 shows a perspective view of inner arms 109 in an assembled orientation. Catches 123 form recesses 125 that extend along the length of frame 103 and allow outer arms 107 to couple with inner arms 109. It is contemplated that a higher or lower number of catches can be used. As shown in FIG. 7, at least two inner arms 109 can extend from each of catch 123. In some embodiments, at least one of inner arms 109 is removably coupled with one of catch 123. It is contemplated that catches 123 and inner arms 109 can form a saddle (i.e., a portion of frame 103 that is positioned over or around one or more vertices of crystals 105) for a vertex of one or more of crystals 105.

FIG. 8 shows another view of system 100 having frame 103 and crystals 105. Crystals 105 can comprise a first crystal 131 and a second crystal 133 that are adjacent to one another as shown in FIG. 8. It is contemplated that inner arms 109 and outer arms 107 extend over a portion of first crystal 131 and second crystal 133 to thereby orient first crystal 131 with respect to second crystal 133 such that a face of first crystal 131 contacts a face of second crystal 133. Additionally, the face-to-face orientation between crystals 105 can be maintained throughout the length of frame 103 such that crystals are oriented in a tetrahelical orientation.

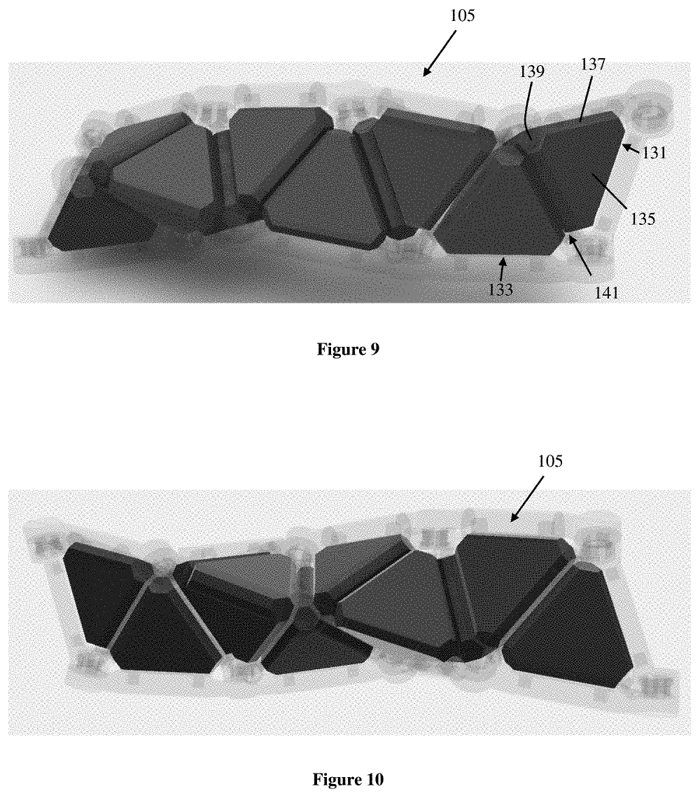

The crystal orientation of crystals 105 can be better viewed in FIGS. 9-10. Crystals 105 each comprise faces 135, edges 137 and vertices 139. As shown in FIGS. 9-10, crystals 105 are oriented in a tetrahelix. Crystals 105 contact one another throughout the length of system 100. Typically, the faces of adjacent crystals 105 contact one another (e.g., see, faces of first crystal 131 and second crystal 133 that contact in area 141 in FIG. 9). In some instances, the vertices of several crystals 105 can be oriented to point to a common location (e.g., the location of catch 123).

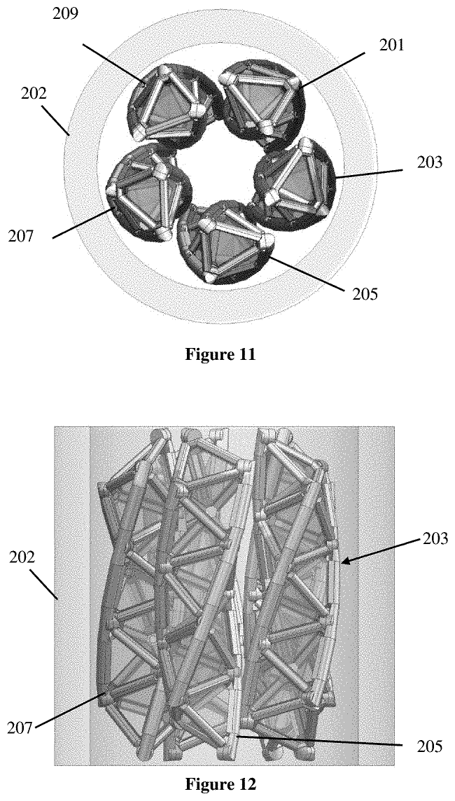

It is contemplated that one or more systems having a frame and crystals can be disposed within a pipe where 1 to 32 crystals can be disposed within the pipe. The crystals can be retained by the frames of the one or more systems to form various arrays, such as tetrahelical, linear, spiral, phi ratio/Fibonacci spiral or other array forms. For example, FIGS. 11-12 show a first system 201, a second system 203, a third system 205, a fourth system 207, and a fifth system 209 disposed within a pipe 202. Each of first system 201, second system 203, third system 205, fourth system 207, and fifth system 209 can have the same features as system 100 (e.g., frame with outer and inner arms, crystals, etc.). It is contemplated that one or more of first system 201, second system 203, third system 205, fourth system 207, and fifth system 209 can fixed within the inner circumference of pipe 202. As a fluid (e.g., water) passes through pipe 202, the fluid contacts one or more of first system 201, second system 203, third system 205, fourth system 207, and fifth system 209 and it is treated or improved. As described above, the vitality of living systems (e.g., plants) can be improved by feeding the treated or improved fluid (e.g., water) to the living system. It is contemplated that pipe 202 can be a segment of a fluid distribution system (e.g., water distribution system).

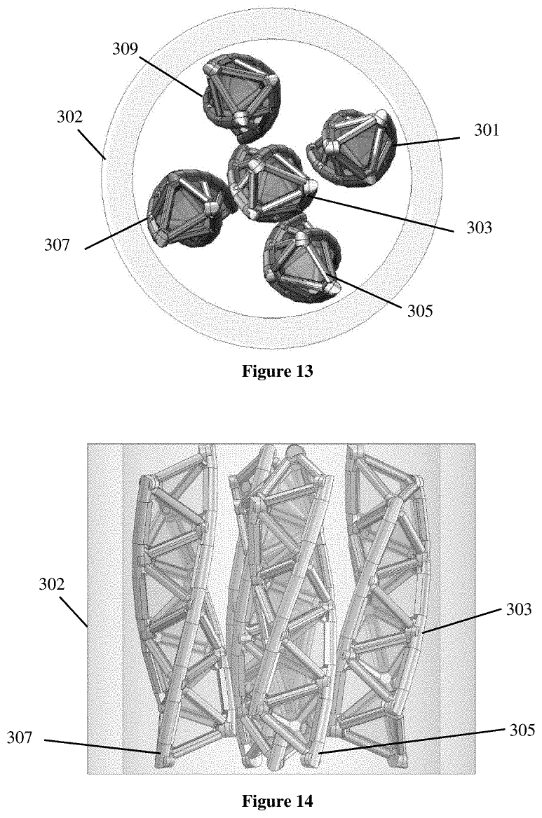

FIGS. 13-14 show a first system 301, a second system 303, a third system 305, a fourth system 307, and a fifth system 309 disposed within a pipe 302. Each of first system 301, second system 303, third system 305, fourth system 307, and fifth system 309 can have the same features as system 100 (e.g., frame with outer and inner arms, crystals, etc.). It is contemplated that one system (e.g., second system 303) can be positioned at the center, and four other systems can be positioned around the center system. It is contemplated that pipe 302 can be a segment of a fluid distribution system (e.g., water distribution system).

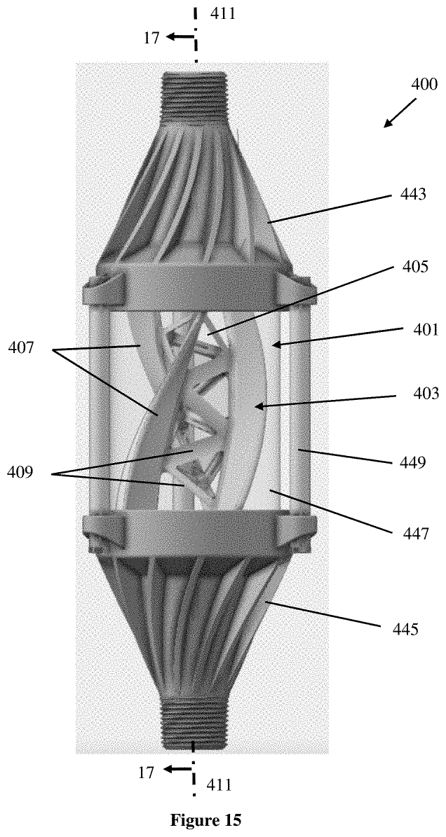

FIG. 15 shows another embodiment of a system 401 comprising a frame 403 and crystals 405. Similar to the systems described above (e.g., system 100), frame 403 comprises outer arms 407 and inner arms 409 that retain crystals 405. As shown in FIG. 15, outer arms 407 collectively wind about a major axis 411 of frame 403. Inner arms 409 extend within outer arms 107. It is contemplated that outer arms 407 and inner arms 409 collectively form a tetrahelix to thereby hold crystals 105 in a tetrahelical orientation. Additionally, the same crystals described in system 100 can be used in system 401.

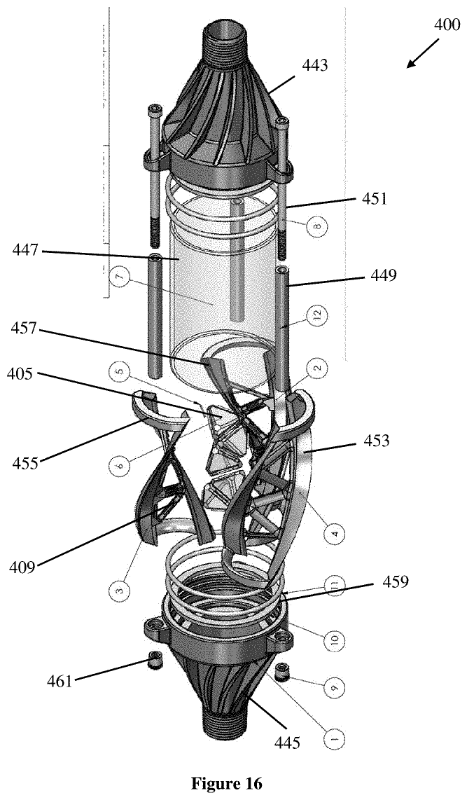

System 401 can be installed in new or existing water systems to treat water via contact between the water and system 401. FIG. 15 shows system 401 disposed within a housing 400. It is contemplated that housing 400 can be installed in new or existing water systems. FIG. 16 shows that housing 400 comprises a first end cap 443, a second end cap 445, a tube 447, cylindrical spacers 449, a fasteners 451, seals 459, and a fastener caps 461. It is contemplated that tube 447 can be manufactured from fused silica (quartz) to allow users to view system 401 while in operation. Additionally, or alternatively, first end cap 443, second end cap 445, and seals 459 hold the water pressure of the new or existing water system. First end cap 443 and second end cap 445 can be made of a metal alloy (e.g., 316 Stainless Steel, Ti-6A1-4V, etc.) or other suitable materials.

Housing 400 can be assembled or disassembled to remove system 401 by removing fasteners 451 from fastener caps 461 to separate first end cap 443 and second end cap 445. It is contemplated that frame 403 can be separated into frame components. For example, frame 403 can be separated into a first frame component 453, a second frame component 455, and a third frame component 457 that removable couple with one another. Each of first frame component 453, second frame component 455, and third frame component 457 comprises at least one of inner arms 409. It is contemplated that first frame component 453, second frame component 455, and third frame component 457 removably couple one another using magnets or mechanical couplings (e.g., male-female connectors, screw connectors, etc.).

Additionally, or alternatively, at least one of first frame component 453, second frame component 455, and third frame component 457 can comprise a first portion of one of outer arms 407, and at least one of first frame component 453, second frame component 455, and third frame component 457 can comprise a second portion of one of outer arms 407, such that one of outer arms 407 is formed when the first portion and second portions are combined. For example, at least one of outer arms 407 can be formed when first frame component 435 is coupled to second frame component 455.

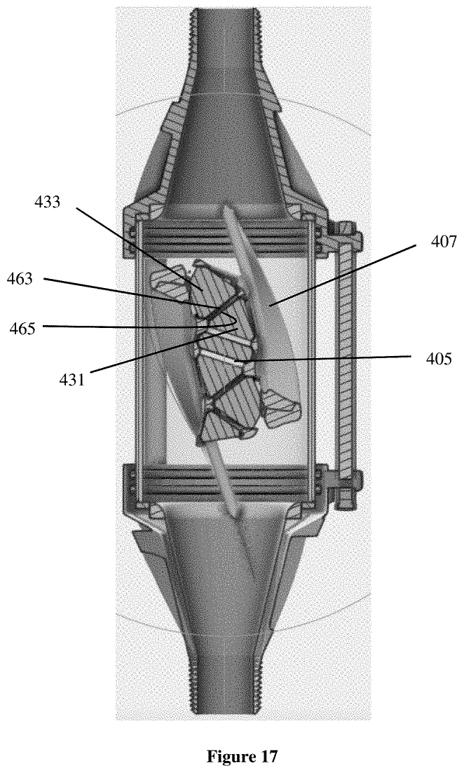

FIG. 17 shows a cross-sectional view of housing 400 and system 401. Crystals 405 can comprise a first crystal 431 and a second crystal 433 that are adjacent to one another. It is contemplated that inner arms 409 and outer arms 407 extend over a portion of first crystal 431 and second crystal 433 to thereby orient first crystal 431 with respect to second crystal 433, such that a face 465 of first crystal 431 contacts a face 463 of second crystal 433. Additionally, the face-to-face orientation between crystals 405 can be maintained throughout the length of frame 403 such that crystals are oriented in a tetrahelical orientation.

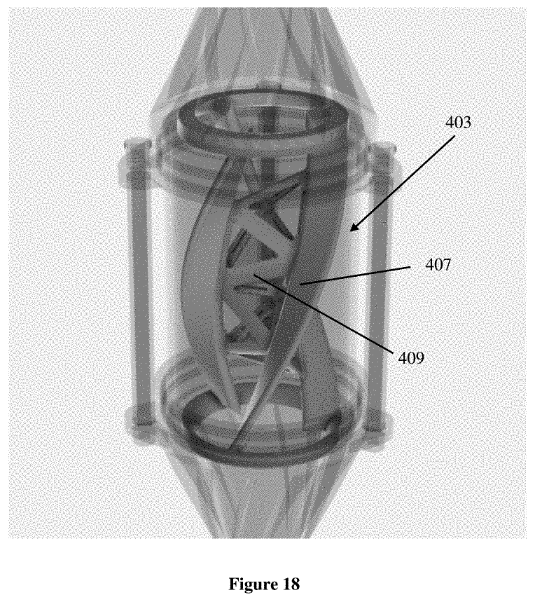

FIG. 18 shows a perspective view of frame 403 with outer arms 407 and inner arms 409. The number of outer arms 407 is three as shown in FIG. 18. However, it is contemplated that other frames can have a higher or lower number of frame arms. It is contemplated that outer arms 407 are shaped as vanes or blades that are designed to cause water to vortex or spin around crystals 405 as the water flows over system 401. The vortex or spin motion created by outer arms 407 is believed to further improve or treat a fluid (e.g., water). Such treated or improved water can be fed to living systems (e.g., plants) to increase their vitality.

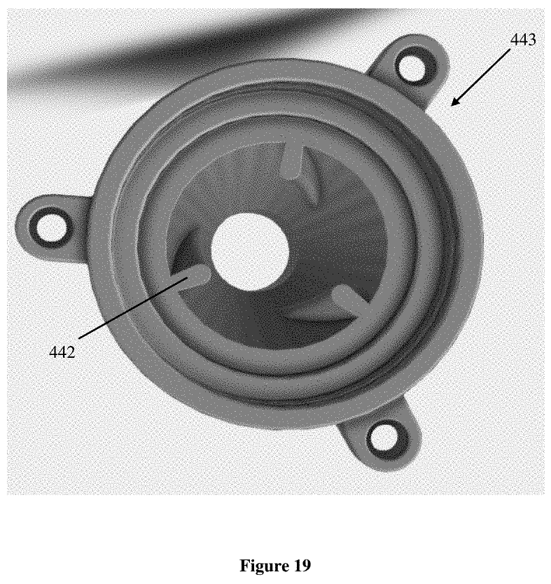

FIG. 19 shows a bottom perspective view of first end cap 443. First end cap 443 comprises internal fins 442 that help water or other fluids keep laminar flow through housing 400. It is contemplated that laminar flow through housing 400 enhances the water flow as it passes through crystals 405. Although first end cap 443 is shown with internal fins 442, it is contemplated that second end cap 445 also comprises internal fins.

Although the systems are described as being in direct contact with a fluid (e.g., water), it is contemplated that such systems can provide the same or similar benefits described herein when placed within a pre-determined distance from the fluid or substance. Additionally, or alternatively, a system can be placed in a tank that contains a fluid or substance and left within the tank or removed after the tank at a pre-determined time, and thereby provide the benefits described herein.

Furthermore, although crystals are described above, it is contemplated that other geometric solids can be housed in the assembly. For example, contemplated systems can comprise a frame and a gem that is retained by the frame.

It should be appreciated that a method of increasing one or more of a growth density, growth rate, seed viability, pathogen resistance, and phytonutrient concentration of a plant is contemplated. The method comprises steps of (i) contacting a substance (e.g., water, plant supplement, etc.) with a system comprising crystals retained by a frame to thereby produce an improved or treated substance, and (ii) feeding the improved or treated substance to the plant in an amount sufficient to increase one or more of a growth density, growth rate, seed viability, pathogen resistance, and phytonutrient concentration of a plant. It should be appreciated that contemplated systems include those described herein.

Additionally, or alternatively, a method of treating water to produce treated water is contemplated. Water is fed to a water treatment system comprising (i) a frame having outer arms that collectively wind about a major axis of the frame, and inner arms that extend within the outer arms and (ii) crystals disposed within the frame in an amount sufficient to cause the water to spin as it flows across the water treatment system thereby producing the treated water. It is contemplated that the water treatment system is identical to the various systems described herein (e.g., system 100, system 401, etc.) with or without a housing (e.g., housing 400). Preferably, prior to feeding the water to the water treatment system, the crystals are exposed to electromagnetic field in an amount sufficient to thereby cause oscillation of the piezoelectric axis of the crystals.

Additionally, or alternatively, a method of improving a living system with treated water is contemplated. Water is fed to a water treatment system comprising (i) a frame having outer arms that collectively wind about a major axis of the frame, and inner arms that extend within the outer arms and (ii) crystals disposed within the frame to thereby produce treated water. The treated water is fed to the living system to thereby improve the living system.

It is contemplated that the water treatment system is identical to the various systems described herein (e.g., system 100, system 401, etc.) with or without a housing (e.g., housing 400). Furthermore, prior to feeding the water to the water treatment system, the crystals can be exposed to electromagnetic field in an amount sufficient to thereby cause oscillation of the piezoelectric axis of the crystals. It is contemplated that the living system is a plant, and one or more of growth density, growth rate, seed viability, pathogen resistance, and phytonutrient concentration of the plant is improved.

Experimental Data

The following experimental data is provided to illustrate various aspects of the subject matter presented herein. Results of testing with ARK® crystals on parameters related to biological vitality demonstrate specific increases in growth density, growth rate, seed viability, pathogen resistance, and phytonutrient concentration when test plants are grown with exposure to ARK® crystals. Testing indicates that effects of ARK® crystals can be conveyed via water that has been exposed to or incubated with the crystals.

The precision designed ARK® crystals were provided by ARK Crystal LLC, and were utilized for testing and scientific characterization of their effects on water and plant growth. An electromagnetic-resonance generator designed by Torus Tech LLC—the Harmonic Flux Resonator (“HFR”)—was utilized in treating the quartz crystals with a uniquely circularly modulated EM field, causing oscillation of the piezoelectric (electromechanical) axis of the ARK® crystals. The ARK® crystals were exposed to the circularly modulated EM field of the HFR for a total of 2 hours, and then removed. After which, the crystals were ready for testing as EM modulated ARK®. As part of the evaluation of this study, quartz crystals exposed to this uniquely patterned EM field are considered to have increased constitutive EM field interaction after treatment.

The EM modulated ARK® crystals are affixed in a retainer orienting them in a tetrahelix. The retainer is placed inside of a water-tight container in which water is precisely passed over the tetrahelical fixture containing the ARK® crystals. The water passes through the fixture and is immediately distributed to plant test groups. Plants of the species Raphanus raphanistrum—commonly known as radish—were given water exposed to ARK® crystals. Experimental test groups containing ARK® crystals demonstrated statistically significant improvements in key parameters related to growth, vitality, resiliency to adverse conditions—including increased pathogen resistance—and greater fecundity, as compared to controls.

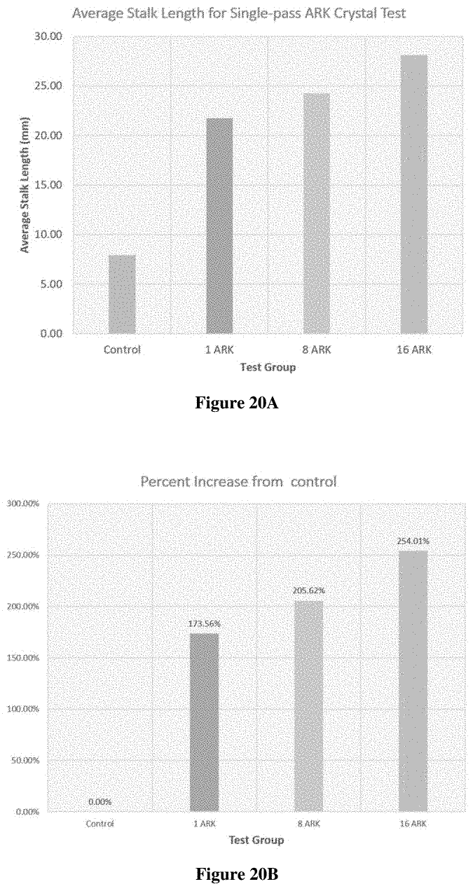

Greater vitality and growth rate was observed in test groups treated with ARK® crystals. In a single-pass experiment, where water does not have prolonged intervals of exposure to the ARK® crystals, but instead passes over the ARK® crystals one time (single-pass) through the tetrahelix ARK® fixture at a flow-rate of 4.0×10⁻⁴ m³/s and is immediately distributed to test groups—in the control, water is not passed over any stationary ARK® crystals as shown FIGS. 20A and 20B.

In FIGS. 19A and 19B, each test group represents the average (in mm) of 30 point measurements (n=30) for test groups in single pass Ark® crystal experimentation. The control group, which had no exposure to ARK® crystals, had the lowest average stalk length. The average stalk length was seen to increase concordantly with increasing numbers of ARK® crystals (a dose-dependent response), where the number of ARK® crystals increases from 1, to 8, to 16 in experimental test groups. The test group receiving water passed over 16 ARK® crystals had an average stalk length 254.01% greater than the control.

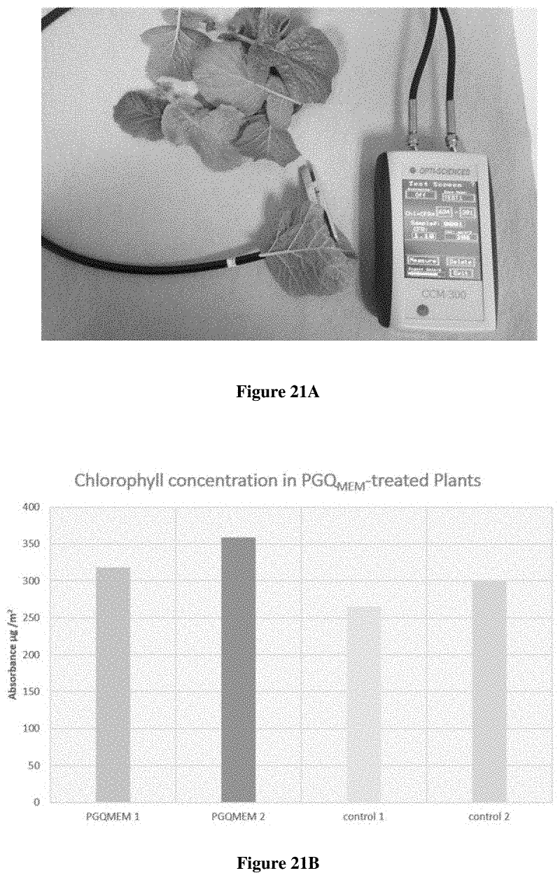

Greater phytonutrient content, water utilization, and increased photosynthesis rates were observed in ARK® treated samples using spectrophotometric analysis shown in FIGS. 21A and 21B. Spectral analysis of wheatgrass showed a 420.54% to 7,858.12% greater relative intensity in ARK® treated groups versus control. Spectrophotometric measurement of chlorophyll content demonstrated an average 35.13% greater chlorophyll content in ARK® treated groups compared to control groups. Relative spectral analysis demonstrates increased growth density, a function of increased seed germination and growth rate—and most importantly, greater phytonutrient content. In radish plants, increased phytonutrient content was measured by direct spectrophotometric analysis of the leaves.

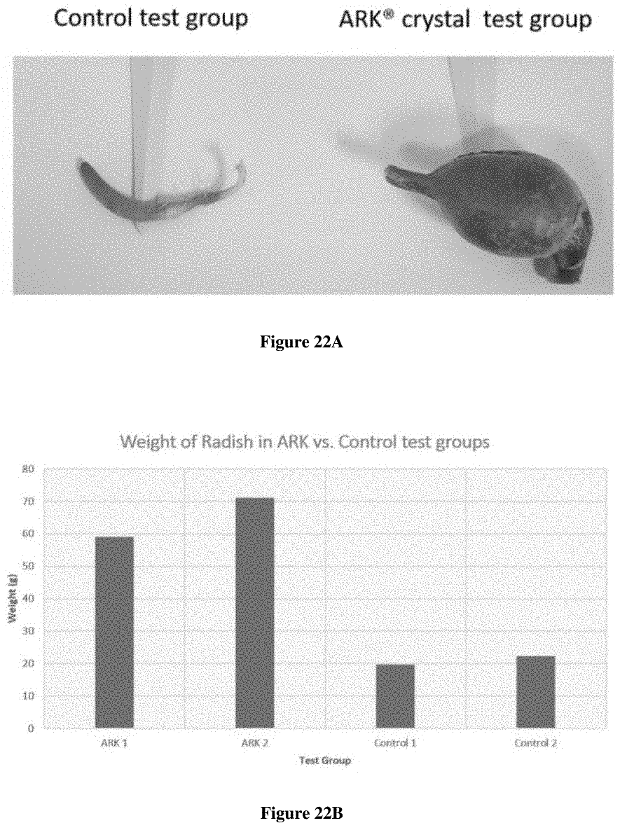

In addition to observing increased seed germination and overall growth rates after germination, quatitiation of fruit and seed production demonstrates statistically significant increases of several key parameters in ARK® treated test groups. Increased number of fruiting bodies, as well as increased weight, volume, and symmetry were observed in ARK® treated test groups of Raphanus raphanistrum shown in FIGS. 22A and 22B. Test groups treated with ARK® crystals exhibited greater fruiting body production with an average of 218.67% greater weight.

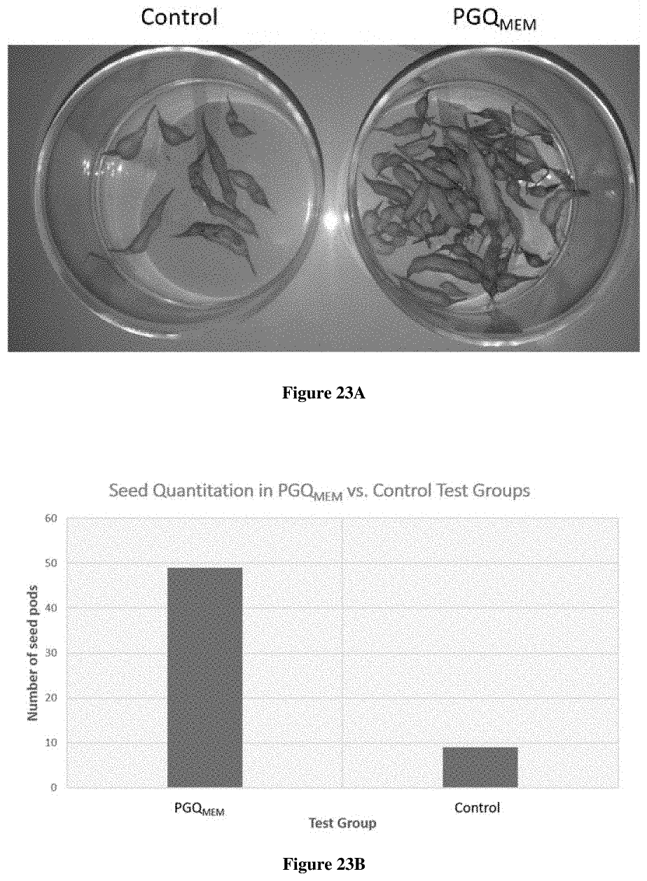

Test groups similarly treated with ARK® crystals showed significant increase in seed production shown in FIGS. 23A and 23B with an average increase of 444.4% over controls. In addition to qualitatively significant improvements in ARK® crystal treated groups, quantitative measurements of ARK® crystal treated test groups yield demonstrable improvements in fruit and seed production. Such results indicate potential benefits for sustainable agricultural practices.

Thus, the results demonstrate statistically significant improvements in all key parameters in test groups treated with water exposed to ARK® crystals, as compared to controls. These results suggest that the ARK® crystals have a significant beneficial affect on water and the biological system. The results indicate that ARK® crystals may have beneficial effects that extend beyond plants alone and may potentially benefit other living organisms as well, given the indication that the beneficial effects seem to be mediated in part by water—which comprises all living systems.

It should be apparent, however, to those skilled in the art that many more modifications besides those already described are possible without departing from the inventive concepts herein. The inventive subject matter, therefore, is not to be restricted except in the spirit of the disclosure. Moreover, in interpreting the disclosure all terms should be interpreted in the broadest possible manner consistent with the context. In particular the terms “comprises” and “comprising” should be interpreted as referring to the elements, components, or steps in a non-exclusive manner, indicating that the referenced elements, components, or steps can be present, or utilized, or combined with other elements, components, or steps that are not expressly referenced.

What is claimed is:

1. A system, comprising:
a frame comprising outer arms that collectively wind about a major axis of the frame, and inner arms that extend within the outer arms;
a first crystal having a first face;
a second crystal having a first face; and
wherein, when the first and second crystals are disposed within the frame, at least one of the outer arms and at least one of the inner arms extend over (i) a portion of the first crystal and (ii) a portion of the second crystal to thereby orient the first crystal with respect to the second crystal such that the first face of the first crystal contacts the first face of the second crystal.

2. The system of claim 1, wherein the outer arms comprise a first outer arm, a second outer arm, and a third outer arm that collectively wind about the major axis of the frame.

3. The system of claim 2, wherein the first, second, and third outer arms and the inner arms collectively form a tetrahelix.

4. The system of claim 2, wherein the inner arms comprise a first inner arm and a second inner arm, and further wherein the first inner arm extends between the first outer arm and the second outer arm, and the second inner arm extends between the second outer arm and the third outer arm.

5. The system of claim 2, wherein the inner arms comprise a first inner arm and a second inner arm that both extend between the first outer arm and the second outer arm, and further wherein the frame comprises an opening having an outer boundary defined by the first inner arm, the second inner arm, and the first outer arm.

6. The system of claim 5, wherein the first crystal comprises a second face, and wherein a portion of the second face is disposed adjacent the opening when the first crystal is disposed within the frame.

7. The system of claim 1, wherein one or more of the first crystal and the second crystal is a quartz crystal.

8. The system of claim 1, wherein one or more of the first crystal and the second crystal is a tetrahedral shape.

9. The system of claim 8, wherein one or more of the first crystal and the second crystal has a modified tetrahedral shape having four triangular faces joined at four truncated vertices and six chamfered edges.

10. The system of claim 1, further comprising a third crystal having a first face, and wherein, when the first, second, and third crystals are disposed within the frame, at least one of the outer arms and at least one of the inner arms extend over (i) the portion of the first crystal and (ii) the portion of the second crystal, and (iii) a portion of the third crystal to thereby orient the first crystal with respect to the second crystal and the second crystal with respect to the third crystal such that the first face of the first crystal contacts the first face of the second crystal and the first face of the third crystal contacts a second face of the second crystal.

11. A system, comprising:
a frame comprising outer arms that collectively wind about a major axis of the frame, and inner arms that extend within the outer arms;
a first crystal having a first face;
a second crystal having a first face;
wherein a first set of inner arms and outer arms defines a first area;
wherein a second set of inner arms and outer arms defines a second area; and
wherein the first face of the first crystal is positioned to contact the first face of the second crystal when the first crystal is disposed in the first area and the second crystal is disposed in the second area.

12. The system of claim 11, wherein the outer arms comprise a first outer arm, a second outer arm, and a third outer arm that collectively wind about the major axis of the frame.

13. The system of claim 12, wherein the first, second, and third outer arms and the inner arms collectively form a tetrahelix.

14. The system of claim 12, wherein the inner arms comprise a first inner arm and a second inner arm, and further wherein the first inner arm extends between the first outer arm and the second outer arm, and the second inner arm extends between the second outer arm and the third outer arm.

15. The system of claim 12, wherein the inner arms comprise a first inner arm and a second inner arm that both extend between the first outer arm and the second outer arm, and further wherein the frame comprises an opening having an outer boundary defined by the first inner arm, the second inner arm, and the first outer arm.

16. The system of claim 15, wherein the first crystal comprises a second face, and wherein a portion of the second face is disposed adjacent the opening when the first crystal is disposed within the frame.

17. The system of claim 11, wherein one or more of the first crystal and the second crystal is a quartz crystal.

18. The system of claim 11, wherein one or more of the first crystal and the second crystal is a tetrahedral shape.

19. The system of claim 18, wherein one or more of the first crystal and the second crystal has a modified tetrahedral shape having four triangular faces joined at four truncated vertices and six chamfered edges.

20. The system of claim 1, further comprising a third crystal having a first face, and wherein a third set of inner arms and outer arms defines a third area, and further wherein the first face of the third crystal is positioned to contact a second face of the second crystal when the second crystal is disposed in the second area and the third crystal is disposed in the third area.
